(19) United States
(12) Patent Application Publication
(10) Pub. No.: US 2015/0198109 A1
(43) Pub. Date: Jul. 16, 2015

(54) ALTERNATIVE FUEL MODULE FOR SPARK IGNITION FUEL INJECTED ENGINES

(71) Applicant: Ryan Christopher Truax, Temple, TX (US)

(72) Inventor: Ryan Christopher Truax, Temple, TX (US)

(21) Appl. No.: 14/597,655

(22) Filed: Jan. 15, 2015

Related U.S. Application Data
(60) Provisional application No. 61/927,557, filed on Jan. 15, 2014.

(51) Int. Cl. F02D 41/30; F02D 41/04

(52) U.S. Cl. CPC F02D 41/3005; F02D 41/04

(57) ABSTRACT

Some embodiments of the present disclosure include a system for allowing spark ignition fuel injected engines to function on a plurality of fuels. The system may include an engine system including an engine control module operatively attached to a fuel injector, and a fuel tank attached to the fuel injector, a fuel content sensor configured to sense a content of a fuel in the engine system before combustion of the fuel, and a fuel control module placed inline with the fuel injector and the fuel content sensor, the fuel control module configured to receive fuel content information from the fuel content sensor and make a change to the fuel injector pulse width based on the fuel content information, if necessary.

### RELATED APPLICATION

This application claims priority to provisional patent application U.S. Ser. No. 61/927,557 filed on Jan. 15, 2014, the entire contents of which is herein incorporated by reference.

### BACKGROUND

The embodiments herein relate generally to engines, and more particularly, to an alternative fuel module for spark ignition fuel injected engines, allowing an engine to use two different types of fuel.

Most engines can only run on one type of fuel. Conventional devices that aim to solve this problem are reactive in design, meaning that they respond based on what the engine has already done. Thus, reactive systems do not work properly, because they are slow to respond due to relying on information received after combustion has already occurred.

Additionally, conventional systems make constant changes to the fuel system to run on ethanol. Conventional systems rely on the factory installed computer in a vehicle to pull fuel back so that it will still run correctly on conventional gasoline. Thus, other systems affect the functionality of the factory installed computer. This limits the system and often maxes it out, because the change required is often more than it is capable of achieving.

Therefore, what is needed is an alternative fuel module for spark ignition fuel injected engines that senses fuel before combustion and makes any necessary adjustments needed, allowing the engine to run on two different types of fuel.

### SUMMARY

Some embodiments of the present disclosure include a system for allowing spark ignition fuel injected engines to function on a plurality of fuels. The system may include an engine system including an engine control module operatively attached to a fuel injector, and a fuel tank attached to the fuel injector, a fuel content sensor configured to sense a content of a fuel in the engine system before combustion of the fuel, and a fuel control module placed inline with the fuel injector and the fuel content sensor, the fuel control module configured to receive fuel content information from the fuel content sensor and make a change to the fuel injector pulse width based on the fuel content information, if necessary.

### BRIEF DESCRIPTION OF THE FIGURES

The detailed description of some embodiments of the invention is made below with reference to the accompanying figures, wherein like numerals represent corresponding parts of the figures.

FIG. 1 is a schematic view of one embodiment of the present invention with the fuel content sensor (FCS) on the return side of the fuel system.

FIG. 2 is a schematic view of one embodiment of the present invention with the FCS on a returnless fuel system.

FIG. 3 is a schematic view of one embodiment of the present invention with the FCS in the fuel tank.

FIG. 4 is a schematic view of one embodiment of the present invention with the FCS on the pressure side of the fuel system.

### DETAILED DESCRIPTION OF CERTAIN EMBODIMENTS

In the following detailed description of the invention, numerous details, examples, and embodiments of the invention are described. However, it will be clear and apparent to one skilled in the art that the invention is not limited to the embodiments set forth and that the invention can be adapted for any of several applications.

The device of the present disclosure may be used to allow an engine to run on multiple types of fuel and may comprise the following elements. This list of possible constituent elements is intended to be exemplary only, and it is not intended that this list be used to limit the device of the present application to just these elements. Persons having ordinary skill in the art relevant to the present disclosure may understand there to be equivalent elements that may be substituted within the present disclosure without changing the essential function or operation of the device.

1. Fuel Control Module

2. Fuel Content Sensor (FCS)

The various elements of the alternative fuel module for spark ignition fuel injected engines for allowing an engine to run off of multiple types of fuel of the present disclosure may be related in the following exemplary fashion. It is not intended to limit the scope or nature of the relationships between the various elements and the following examples are presented as illustrative examples only.

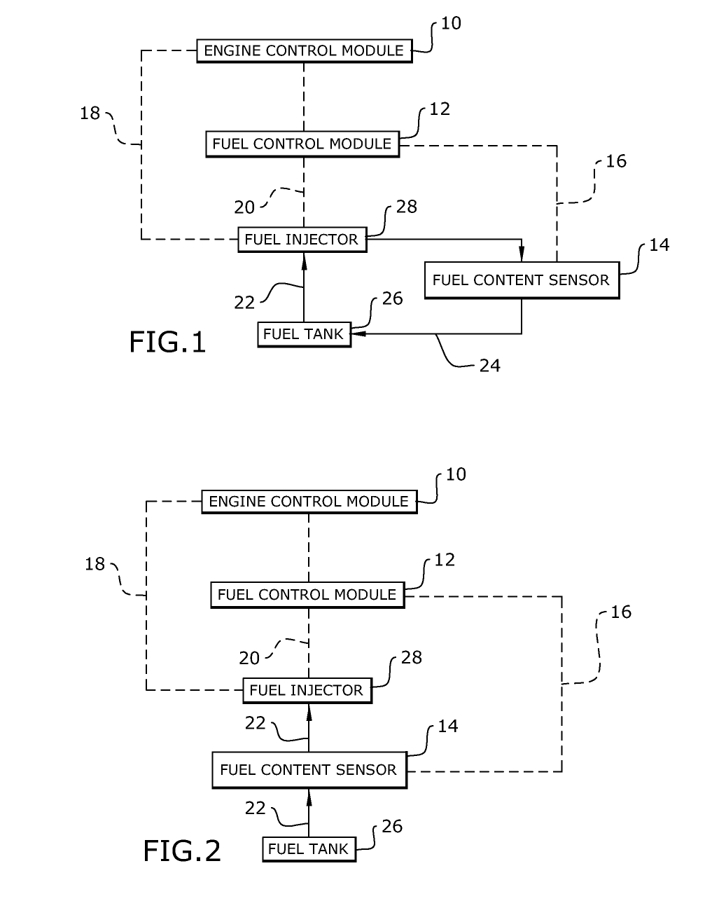

By way of example, and referring to FIGS. 1-4, some embodiments of the fuel module of the present disclosure comprise a system for allowing spark ignition fuel injected engines to run off of multiple fuels, the system comprising a fuel control module 12 placed inline with a fuel injector 28 and a fuel content sensor 14 configured to sense the content of the fuel prior to combustion in the engine, wherein the fuel control module 12 receives the fuel content information from the fuel content sensor 14 and makes the necessary change to the pulse width, if needed. For example, if the fuel content sensor 14 senses that the fuel comprises the fuel intended to be used with the engine per the factory system (i.e., standard fuel), the fuel control module 12 will make no changes and, thus, the factory installed engine control module 10 may continue to work without any interference. Alternatively, if the fuel content sensor 14 senses that the fuel comprises a fuel other than the standard fuel, or the standard fuel mixed with a non-standard fuel, the fuel control module 12 will make the necessary change to the injector pulse width, allowing the engine to run off of the alternate form of fuel.

As shown in FIG. 1, some embodiments of the present invention include a system comprising the fuel content sensor 14 on the return side of the fuel system, wherein the fuel content sensor 14 is connected to the fuel return line 24 between the fuel injector 28 and the fuel tank 26, wherein the engine control module 10 is configured to provide power to the fuel injector 28 by an injector power connection 18 and is operatively connected to the fuel control module 12, which is configured to control the operation of the fuel injector 28, wherein the fuel control module 12 is operatively connected to the fuel injector 28 by an injector ground 20. The fuel content sensor 14 is also operatively connected to the fuel control module 12 by, for example, a signal wire 16. In this embodiment, the fuel content sensor 14 is configured to sense the composition of the fuel as it returns from the fuel injector 28 to the fuel tank 26.

Alternatively, in another embodiment and as shown in FIG. 2, the fuel control sensor 14 may be used in a system that does not include a return line and, thus, may be installed on the fuel feed line 22 between the fuel tank 26 and the fuel injector 28. The fuel content sensor 14 may again be operatively connected to the fuel control module 12 by, for example, a signal wire 16, wherein, based on the fuel content information sensed by the fuel content sensor 14, the fuel control module 12 may change the injector pulse width, if necessary.

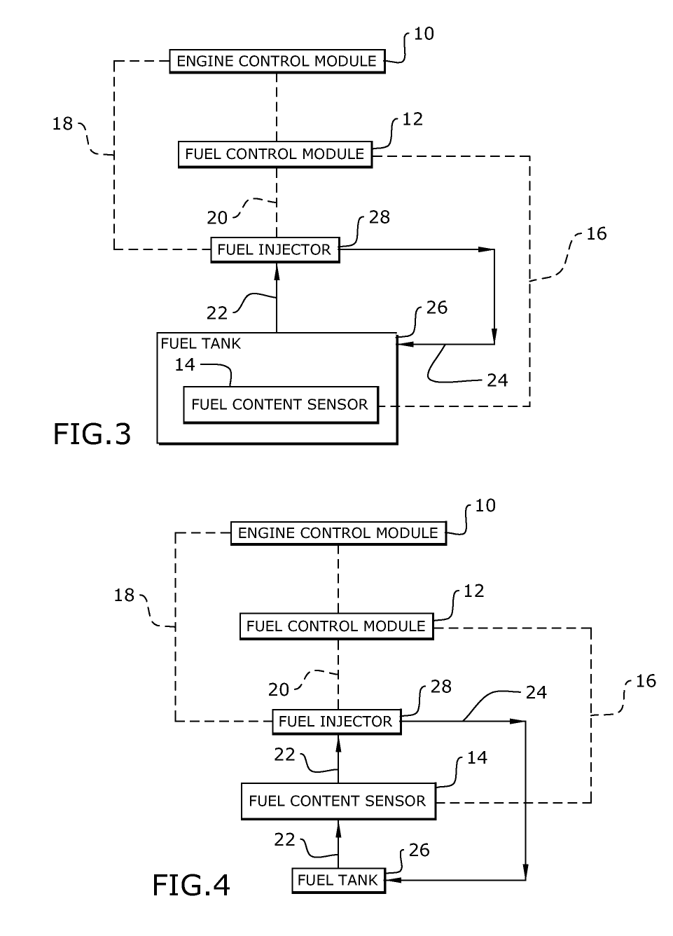

In yet a further embodiment and as shown in FIG. 3, the fuel content sensor 14 may be physically located within the fuel tank 14, wherein the fuel control sensor 14 is operatively attached to the fuel control module 12 by, for example, a signal wire 16, and the fuel content sensor 14 is configured to sense the composition of the fuel as soon as it is placed into the fuel tank 14. This type of system may either have a fuel return line 24, as shown in FIG. 3 or, alternatively, may be a returnless system, similar to that shown in FIG. 2. The fuel content sensor 14 may again be operatively connected to the fuel control module 12 by, for example, a signal wire 16, wherein, based on the fuel content information sensed by the fuel content sensor 14, the fuel control module 12 may change the injector pulse width, if necessary.

In another embodiment and as shown in FIG. 4, the fuel content sensor 14 may be located on the fuel feed line 22 between the fuel tank 26 and fuel injector 28, similar to that in FIG. 2, except the system may also have a fuel return line 24 attaching the fuel injector 28 to the fuel tank 26. The fuel content sensor 14 may again be operatively connected to the fuel control module 12 by, for example, a signal wire 16, wherein, based on the fuel content information sensed by the fuel content sensor 14, the fuel control module 12 may change the injector pulse width, if necessary.

In any case, the fuel content sensor 14 may be configured to sense the composition of the fuel before it is injected into the engine and, thus, before combustion. The number of injector grounds 20 may vary depending on the number of fuel injectors 28 the engine has. Only one fuel control module 12 may be required to control any number of fuel injectors 28. Thus, there does not need to be a separate fuel control module 12 for each fuel injector 28. The system may be installed inline with a current system designed to be run on one fuel, resulting in the system being able to run on at least two separate fuels or a mixture thereof.

The fuel content sensor 14 may sense the content or composition of the fuel and provide this information to the fuel control module 12. The fuel control module 12 may be programmed to determine what the appropriate pulse width of the injector 28 is based on the content of the fuel and change the pulse width, if needed. Thus, the functioning of the factory installed engine control module 10 may be unchanged even with use of the system of the present disclosure. Thus, the system may be proactive rather than other conventional systems, which are reactive. Additionally, the fuel control module 12 and fuel content sensor 14 may be considered an external, secondary, or piggyback fuel injector driver having the ability to modify the signals, as needed, to the injector 28 for proper fuel mixture when running the engine with more than one fuel.

Additional sensors may be added to the system of the present disclosure. For example, an oxygen sensor, an air metering sensor, a fuel temperature sensor, and/or an air temperature sensor may be added to the system. The addition of additional sensors may increase the accuracy of the system.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A system for allowing spark ignition fuel injected engines to function on a plurality of fuels, the system comprising:
an engine system comprising an engine control module operatively attached to a fuel injector, and a fuel tank attached to the fuel injector;
a fuel content sensor configured to sense a content of a fuel in the engine system before combustion of the fuel; and
a fuel control module placed inline with the fuel injector and the fuel content sensor, the fuel control module configured to receive fuel content information from the fuel content sensor and make a change to the fuel injector pulse width based on the fuel content information, if necessary.

2. The system of claim 1, wherein the fuel content sensor is attached to the fuel control module by a signal wire.

3. The system of claim 1, wherein:
the fuel tank is attached to the fuel injector by both a fuel feed line and a fuel return line; and
the fuel content sensor is attached to the fuel return line between the fuel injector and the fuel tank.

4. The system of claim 1, wherein:
the fuel tank is attached to the fuel injector by a fuel feed line; and
the fuel content sensor is attached to the fuel feed line between the fuel tank and the fuel injector.

5. The system of claim 4, further comprising a fuel return line attaching the fuel injector to the fuel tank.

6. The system of claim 1, wherein the fuel content sensor is located in the fuel tank.

7. The system of claim 1, further comprising at lease one sensor selected from the group consisting of an oxygen sensor, an air metering sensor, a fuel temperature sensor, and an air temperature sensor.

8. The system of claim 1, wherein the engine control module is factory installed and unaffected by the operation of the fuel control module.
